(19) United States
(12) Patent Application Publication
(10) Pub. No.: US 2013/0090897 A1
(43) Pub. Date: Apr. 11, 2013

(54) DESIGN SUPPORT APPARATUS, METHOD AND RECORDING MEDIUM

(71) Applicant: FUJITSU LIMITED, Kawasaki-shi (JP)

(72) Inventor: Youji UCHIKURA, Tachikawa (JP)

(73) Assignee: FUJITSU LIMITED, Kawasaki-shi (JP)

(21) Appl. No.: 13/628,429

(22) Filed: Sep. 27, 2012

(30) Foreign Application Priority Data
Oct. 7, 2011 (JP) 2011-223444

(51) Int. Cl. G06F 17/50

(52) U.S. Cl. 703/1

(57) ABSTRACT

A design support apparatus includes a processor, and a memory coupled to the processor, wherein the processor executes a process that includes acquiring first CAD data that indicates a part model that models a part, extracting characteristics of the part model from a plurality of outermost planes of the part model on a plane-by-plane basis, the part model being indicated by the first CAD data, and determining, in the case where the characteristics extracted by the extracting satisfy a certain condition, an outermost plane corresponding to the characteristics as a surface of the part to be mounted on a printed board that is modeled by a printed board model indicated by second CAD data.

### CROSS-REFERENCE TO RELATED APPLICATION

This application is based upon and claims the benefit of priority of the prior Japanese Patent Application No. 2011-223444, filed on Oct. 7, 2011, the entire contents of which are incorporated herein by reference.

### FIELD

The embodiment discussed herein is related to a design support apparatus, a method for design support, and a recording medium for design support program.

### BACKGROUND

There is known a technology which is employed in a system that supports designing of a circuit or the like by cooperatively coordinating CAD data used in a plurality of CAD (Computer Aided Design) systems. For example, in such a technology, three-dimensional CAD data and two-dimensional CAD data are cooperatively coordinated. An example of three-dimensional CAD data is data of electronic components or the like which are used in a CAD system which supports machine design. An example of two-dimensional CAD data is data of printed circuit boards or the like which are used in a CAD system which supports printed board design.

In such a technology, when a three-dimensional electronic part model generated by a CAD system which supports machine design is used in a CAD system which supports printed board design, line drawing information of the electronic part used in the printed board design is manually generated by a user from the three-dimensional model. The generated line drawing information is then used in the printed board design in a two-dimensional CAD.

There is known a CAD system which extracts parameters from three-dimensional CAD data in which the parameters for defining a two-dimensional footprint are preset, and generates the two-dimensional footprint from the parameters.

However, in the above-described conventional technology, there is a problem in that CAD data used in a plurality of CAD systems may not be cooperatively coordinated easily. A description is given using a specific example. In the conventional technology, when CAD data used in different CAD systems are cooperatively coordinated, it takes time for a user to generate the line drawing information of electronic parts. In addition, in the above-described conventional CAD system for generating a footprint, parameters are preset to three-dimensional data by a user or the like. Thus, it takes time to set the parameters. Therefore, in the above-described conventional technology, CAD data used in a plurality of CAD systems may not be cooperatively coordinated easily.

The following is a reference document: Japanese Laid-Open Patent Publication No. 2007-323170.

### SUMMARY

According to an aspect of the invention, a design support apparatus includes a processor, and a memory coupled to the processor, wherein the processor executes a process that includes acquiring first CAD data that indicates a part model that models a part, extracting characteristics of the part model from a plurality of outermost planes of the part model on a plane-by-plane basis, the part model being indicated by the first CAD data, and determining, in the case where the characteristics extracted by the extracting satisfy a certain condition, an outermost plane corresponding to the characteristics as a surface of the part to be mounted on a printed board that is modeled by a printed board model indicated by second CAD data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a system configuration to which a design support apparatus according to a first embodiment is applied;

FIG. 2 illustrates an example of a part model indicated by a first data;

FIG. 3 is an illustration depicting an example of processing performed by the design support apparatus according to the first embodiment;

FIG. 4 is an illustration depicting an example of processing performed by the design support apparatus according to the first embodiment;

FIG. 5 is an illustration depicting an example of processing performed by the design support apparatus according to the first embodiment;

FIG. 6 is an illustration depicting an example of processing performed by the design support apparatus according to the first embodiment;

FIG. 7 is an illustration depicting an example of processing performed by the design support apparatus according to the first embodiment;

FIG. 8 is an illustration depicting an example of processing performed by the design support apparatus according to the first embodiment;

FIG. 9 is an illustration depicting an example of an acquired characteristic;

FIG. 10 is an illustration depicting an example of a center position;

FIG. 11 is an illustration depicting an example of a center position;

FIG. 12 is an illustration depicting an example of a part model;

FIG. 13 is an illustration depicting an example of a shape in an outermost plane of the part model in the example of FIG. 12;

FIG. 14 is an illustration depicting an example of a screen for receiving specification of a mounting surface by a user;

FIG. 15 is an illustration depicting an example of a method for determining whether or not shapes are arranged in a lattice pattern;

FIG. 16 is an illustration depicting an example of processing performed by the design support apparatus according to the first embodiment;

FIG. 17 is an illustration depicting an example of processing performed by the design support apparatus according to the first embodiment;

FIG. 18 is an illustration depicting an example of processing performed by the design support apparatus according to the first embodiment;

FIG. 19 is an illustration depicting an example of processing performed by the design support apparatus according to the first embodiment;

FIG. 20 is an illustration depicting an example of processing performed by the design support apparatus according to the first embodiment;

FIG. 21 is an illustration depicting an example of processing performed by the design support apparatus according to the first embodiment;

FIG. 22 is a method illustrating the steps of cooperative processing according to the first embodiment;

FIG. 23 is a method illustrating the steps of characteristic extraction processing according to the first embodiment;

FIG. 24 is a method illustrating the steps of a mounting surface determination processing according to the first embodiment;

FIG. 25 is a method illustrating the steps of a mounting surface determination processing according to the first embodiment;

FIG. 26 is a method illustrating the steps of footprint generation processing according to the first embodiment;

FIG. 27 is a method illustrating the steps of part mounting region determination processing according to the first embodiment;

FIG. 28 is a method illustrating the steps of height determination processing according to the first embodiment; and

FIG. 29 is a diagram illustrating a computer for executing a design support program.

### DESCRIPTION OF EMBODIMENTS

Hereinafter, embodiments of a design support apparatus, a recording medium for design support program, and a method for design support disclosed in the present application will be described in detail with reference to the accompanying drawings. The embodiments are not intended to limit the technology to be disclosed. The embodiments may be combined as appropriate in a range where processing details do not contradict each other.

### First Embodiment

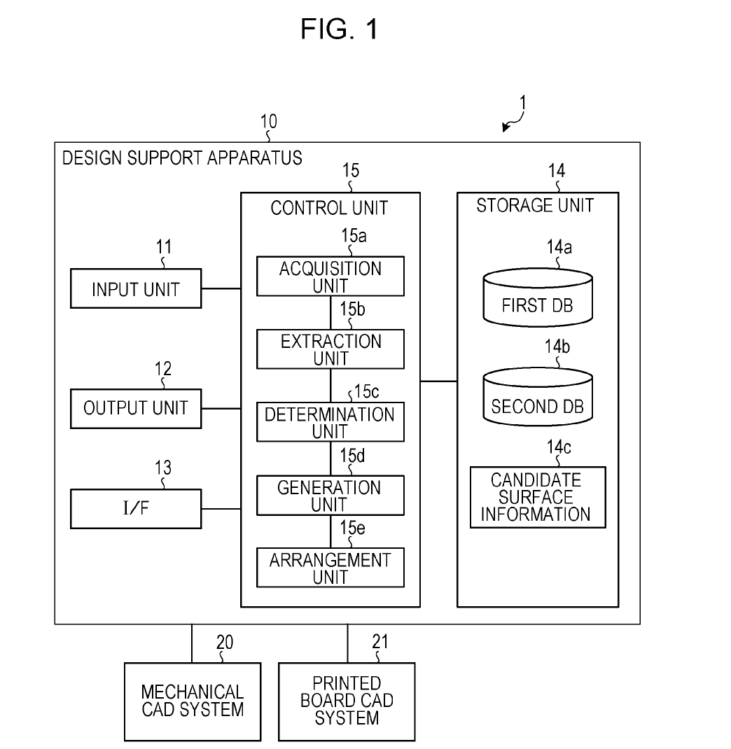

A design support apparatus according to a first embodiment will be described. FIG. 1 illustrates an example of a system configuration to which the design support apparatus according to the first embodiment is applied. In the example of FIG. 1, a system 1 includes a design support apparatus 10, a mechanical CAD system 20, and a printed board CAD system 21. The design support apparatus 10, the mechanical CAD system 20 and the printed board CAD system 21 may communicate with each other.

The mechanical CAD system 20 performs machine design of a machine product, a mechanical unit, and the like which are mounted on a printed board. The mechanical CAD system 20 generates CAD data which defines parts such as a housing, an electronic part, and a mechanical part which are to be designed. A part model is defined by the CAD data. That is to say, the mechanical CAD system 20 generates the CAD data which indicates the part model. In the following description, CAD data indicating a part model is referred to as “first data.”

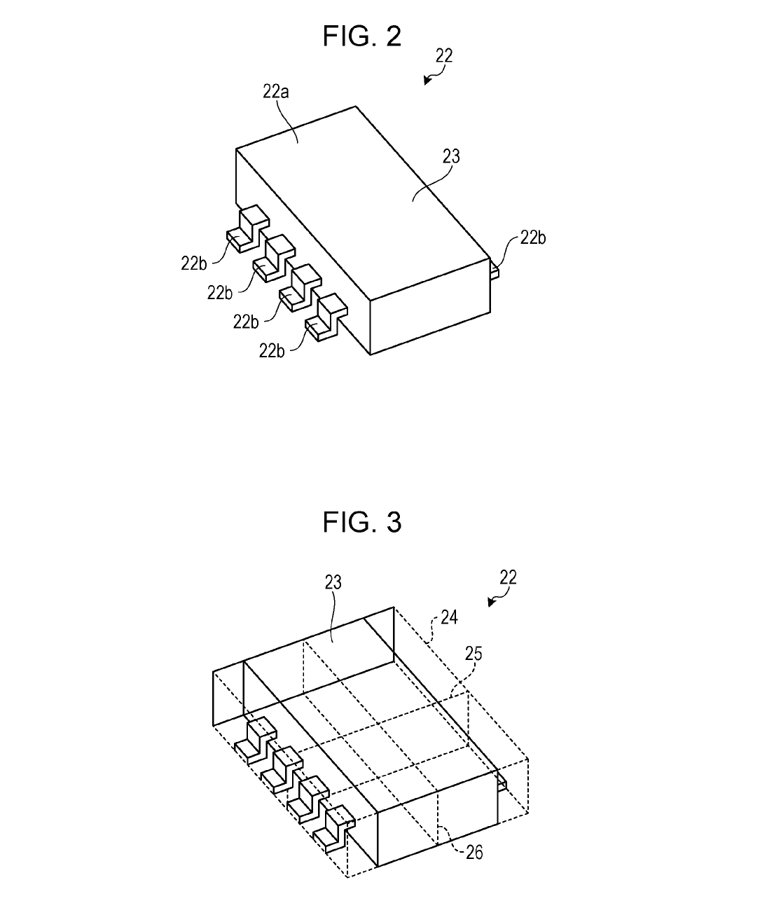

FIG. 2 illustrates an example of a part model indicated by the first data. In the example of FIG. 2, a part model 22 includes a part body 22a and terminals 22b mounted on a footprint.

The printed board CAD system 21 generates CAD data related to a printed board by performing electrical design of an outline of the printed board to be designed, and a wiring pattern on the printed board. A printed board model is defined by the CAD data. That is to say, the printed board CAD system 21 generates the CAD data which indicates the printed board model. Here, the wiring pattern includes a footprint on which terminals such as electronic parts are mounted by soldering or the like. In the following description, CAD data indicating a printed board model is referred to as a “second data.”

The design support apparatus 10 acquires the first data and the second data from the mechanical CAD system 20 and the printed board CAD system 21, respectively. The design support apparatus 10 then extracts characteristics of a part model in a plurality of outermost planes of the part model on a plane-by-plane basis. The design support apparatus 10 then determines an outermost plane to be mounted on a printed board model indicated by the second data in the case where the extracted characteristic satisfies a predetermined condition, the outermost plane corresponding to the characteristic. In this manner, the design support apparatus 10 determines a surface of the part model by automatic processing, the surface being mounted on the printed board model. Therefore, with the design support apparatus 10, a time for a user or the like to determine a surface of the part model is saved, the surface being mounted on the printed board model, and thus CAD data may be cooperatively coordinated easily. In the following description, a surface mounted on the printed board model is denoted as a “mounting surface” in some cases.

[Functional Configuration Of Design Support Apparatus]

As indicated in FIG. 1, the design support apparatus 10 includes an input unit 11, a display unit 12, an I/F (InterFace) 13, a storage unit 14, and a control unit 15.

The input unit 11 inputs a variety of information to the control unit 15. For example, the input unit 11 receives from a user a command for acquiring CAD data from the mechanical CAD system 20 and the printed board CAD system 21, and inputs the received command to the control unit 15. In addition, the input unit 11 receives from a user a command for performing processing such as the below-described cooperative processing, and inputs the received command to the control unit 15. An example of a device of the input unit 11 is an operation reception device such as a mouse or a keyboard.

The output unit 12 outputs various types of information. For example, the output unit 12 is a liquid crystal display or the like, and displays a screen for specifying the below-described mounting surface by the below-described determination unit 15c. In addition, the output unit 12 displays an assembly model in which a part model is arranged on a printed board model by the below-described arrangement unit 15e.

An I/F 13 is configured to communicate between devices. For example, the I/F 13 is connected to the control unit 15 of the design support apparatus 10, the mechanical CAD system 20, and the printed board CAD system 21 via a network (not illustrated). Accordingly, the design support apparatus 10, the mechanical CAD system 20, and the printed board CAD system 21 may communicate with each other.

The storage unit 14 stores various information. For example, the storage unit 14 stores a first database 14a, a second database 14b, and candidate surface information 14c. In the following description, a database is denoted as a “DB.”

The first data is registered to a first DB 14a. For example, the first data acquired from the mechanical CAD system 20 by the below-described acquisition unit 15a is registered to the first DB 14a.

The second data is registered to a second DB 14b. For example, the second data acquired from the printed board CAD system 21 by the below-described acquisition unit 15a is registered to the second DB 14b.

The identification information of an outermost plane which is a candidate for the below-described mounting surface is registered to the candidate surface information 14c. For example, the identification information of an outermost plane is registered to the candidate surface information 14c by the below-described determination unit 15c.

The storage unit 14 is, for example, a semiconductor memory device such as a flash memory, or a storage device such as a hard disk or an optical disk. The storage unit 14 is not limited to the storage device of the above-mentioned type, and may be a RAM (Random Access Memory) or a ROM (Read Only Memory).

The control unit 15 has an internal memory for storing a program and control data which specify various types of processing steps, and performs various processing operations by using the program and the control data. As illustrated in FIG. 1, the control unit 15 has an acquisition unit 15a, an extraction unit 15b, a determination unit 15c, a generation unit 15d, and an arrangement unit 15e.

The acquisition unit 15a acquires the first data and the second data from the mechanical CAD system 20 and the printed board CAD system 21, respectively. For example, upon receiving a command, from the input unit 11, for acquiring CAD data from the mechanical CAD system 20 and the printed board CAD system 21, the acquisition unit 15a performs the following processing. That is to say, the acquisition unit 15a transmits a command to the mechanical CAD system 20 via the I/F 13, the command for transmitting the first data to the design support apparatus 10. Accordingly, the first data is transmitted from the mechanical CAD system 20 to the design support apparatus 10. In addition, the acquisition unit 15a transmits a command to the printed board CAD system 21 via the I/F 13, the command for transmitting the second data to the design support apparatus 10. Accordingly, the first data is transmitted from the mechanical CAD system 20 to the design support apparatus 10. In this manner, the acquisition unit 15a acquires the first data and the second data. Every predetermined time interval, for example, every one hour, the acquisition unit 15a may transmit a command to the mechanical CAD system 20, which is the command for transmitting the first data to the design support apparatus 10, and may transmit a command to the printed board CAD system 21, which is the command for transmitting the second data to the design support apparatus 10.

The acquisition unit 15a registers the received first data to the first DB 14a, and registers the received second data to the second DB 14b. Upon receiving a command for performing cooperative processing from the input unit 11, the acquisition unit 15a acquires the first data from the first DB 14a, and acquires the second data from the second DB 14b.

The extraction unit 15b extracts characteristics of a part model in a plurality of outermost planes of the part model on a plane-by-plane basis.

A description is given using a specific example. The extraction unit 15b extracts a plurality of surfaces of an electronic part model indicated by the first data acquired from the first DB 14a by the acquisition unit 15a. In the example of FIG. 2, the extraction unit 15b extracts six surfaces of the part body 22a of the part model 22 which is an electronic part model.

The extraction unit 15b then extracts a surface with the largest area out of the extracted surfaces. In the example of FIG. 2, the extraction unit 15b extracts a surface 23 from the six surfaces. Subsequently, the extraction unit 15b sets and defines a plane containing the extracted surface with the largest area as a first reference plane. FIG. 3 is an illustration depicting an example of processing performed by the design support apparatus according to the first embodiment. In the example of FIG. 3, the extraction unit 15b sets and defines a plane 24 containing the surface 23 as the first reference plane.

The extraction unit 15b then sets and defines a second reference plane and a third reference plane which are perpendicular to each other, and are perpendicular to the first reference plane 24. Here, each of the second reference plane and the third reference plane is parallel to either one of the extracted surfaces of the electronic part model. In the example of FIG. 3, the extraction unit 15b sets and defines a second reference plane 25 and a third reference plane 26 which are perpendicular to each other, and are perpendicular to the first reference plane 24.

Subsequently, the extraction unit 15b acquires the outermost position of the electronic part model based on the first data. In the following description, the outermost position of the part model is referred to as the “outermost position.” FIG. 4 is an illustration depicting an example of processing performed by the design support apparatus according to the first embodiment. In the example of FIG. 4, the extraction unit 15b acquires six positions 27a to 27f, as the outermost positions, of the maximum coordinate value and the minimum coordinate value for each of the X-axis, the Y-axis, and the Z-axis in the three-dimensional rectangular coordinate system defined in the part model.

The extraction unit 15b then sets and defines a surface at each of the acquired outermost positions, the surface being parallel to any one of the first reference plane, the second reference plane, and the third reference plane. In the following description, each parallel surface is referred to as a “outermost plane.” In the example of FIG. 4, the extraction unit 15b sets and defines an outermost plane 28a which contains the maximum coordinate value 27a on the Z-axis, and is parallel to the first reference plane 24. In the example of FIG. 4, the extraction unit 15b sets and defines an outermost plane 28b which contains the minimum coordinate value 27b on the Z-axis, and is parallel to the first reference plane 24. In the example of FIG. 4, the extraction unit 15b sets and defines an outermost plane 28c which contains the minimum coordinate value 27c on the X-axis, and is parallel to the third reference plane 26. In the example of FIG. 4, the extraction unit 15b sets and defines an outermost plane 28d which contains the maximum coordinate value 27d on the X-axis, and is parallel to the third reference plane 26. In the example of FIG. 4, the extraction unit 15b sets and defines an outermost plane 28e which contains the maximum coordinate value 27e on the Y-axis, and is parallel to the second reference plane 25. In the example of FIG. 4, the extraction unit 15b sets and defines an outermost plane 28f which contains the minimum coordinate value 27f on the Y-axis, and is parallel to the second reference plane 25.

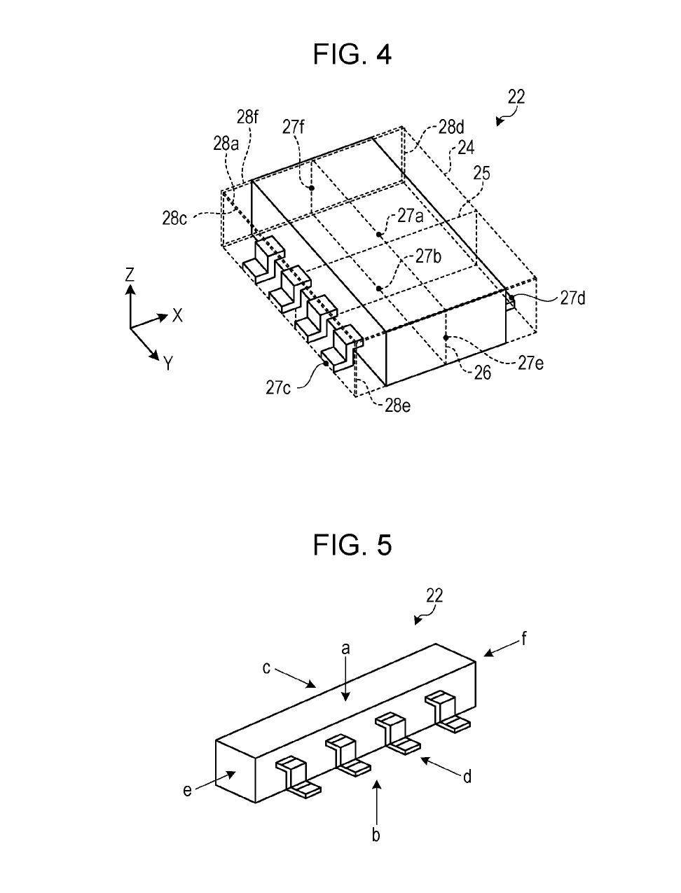

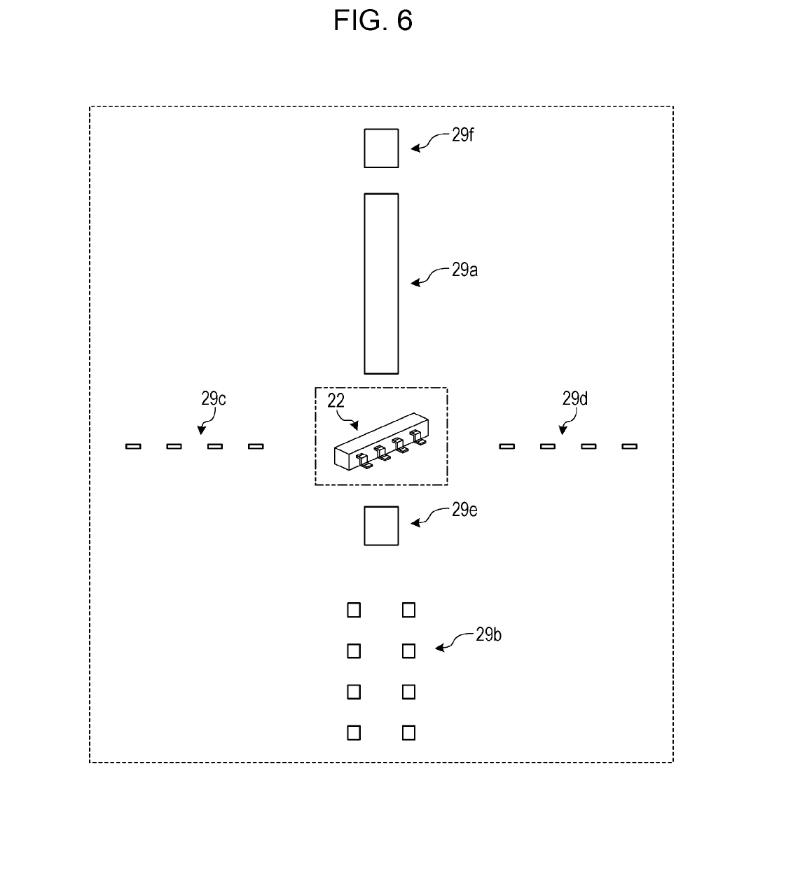

The extraction unit 15b acquires a closed shape on each of the outermost planes of the part model. FIGS. 5 and 6 are illustrations each depicting an example of processing performed by the design support apparatus according to the first embodiment. The example of FIG. 6 illustrates an example of characteristics in the outermost planes 28a to 28f of the part model 22, respectively corresponding to the directions of arrows a to f in the example of FIG. 5. The example of FIG. 6 illustrates a shape 29a of the part model 22 in the outermost plane 28a. The example of FIG. 6 illustrates shapes 29b of the part model 22 in the outermost plane 28b. The example of FIG. 6 illustrates shapes 29c of the part model 22 in the outermost plane 28c. The example of FIG. 6 illustrates shapes 29d of the part model 22 in the outermost plane 28d. The example of FIG. 6 illustrates a shape 29e of the part model 22 in the outermost plane 28e. The example of FIG. 6 illustrates a shape 29f of the part model 22 in the outermost plane 28f.

In the example of FIG. 6, the extraction unit 15b acquires the shapes 29a to 29f of the part model 22 for the respective outermost planes 28a to 28f.

Subsequently, the extraction unit 15b calculates the area of the shape for each outermost plane. In the example of FIG. 6, the area of the closed shape 29a in the outermost plane 28a is calculated to be 30 [mm²] by the extraction unit 15b. In the example of FIG. 6, the area of each of the eight closed shapes 29b in the outermost plane 28b is calculated to be 2.5 [mm²] by the extraction unit 15b. In the example of FIG. 6, the area of each of the four closed shapes 29c in the outermost plane 28c is calculated to be 2 [mm²] by the extraction unit 15b. In the example of FIG. 6, the area of each of the four closed shapes 29d in the outermost plane 28d is calculated to be 2 [mm²] by the extraction unit 15b. In the example of FIG. 6, the area of the closed shape 29e in the outermost plane 28e is calculated to be 10 [mm²] by the extraction unit 15b. In the example of FIG. 6, the area of the closed shape 29f in the outermost plane 28f is calculated to be 10 [mm²] by the extraction unit 15b.

Subsequently, the extraction unit 15b calculates the total of the areas of the shapes for each outermost plane. In the following description, the total of the areas is denoted by the “total area.” In the example of FIG. 6, the total area of the closed shape 29a in the outermost plane 28a is calculated to be 30 [mm²] by the extraction unit 15b. In the example of FIG. 6, the total area of the closed shapes 29b in the outermost plane 28b is calculated to be 20 [mm²] by the extraction unit 15b. In the example of FIG. 6, the total area of the closed shapes 29c in the outermost plane 28c is calculated to be 8 [mm²] by the extraction unit 15b. In the example of FIG. 6, the total area of the closed shapes 29d in the outermost plane 28d is calculated to be 8 [mm²] by the extraction unit 15b. In the example of FIG. 6, the total area of the closed shape 29e in the outermost plane 28e is calculated to be 10 [mm²] by the extraction unit 15b. In the example of FIG. 6, the total area of the closed shape 29f in the outermost plane 28f is calculated to be 10 [mm²] by the extraction unit 15b.

The extraction unit 15b projects the part model on each of the outermost planes, and calculates the area of the projected region. In the example of FIG. 6, the extraction unit 15b projects the part model 22 on each of the outermost planes 28a to 28f, and calculates the area of the projected region for each of the outermost planes 28a to 28f. In the following description, the projected region is referred to as the “projected region.”

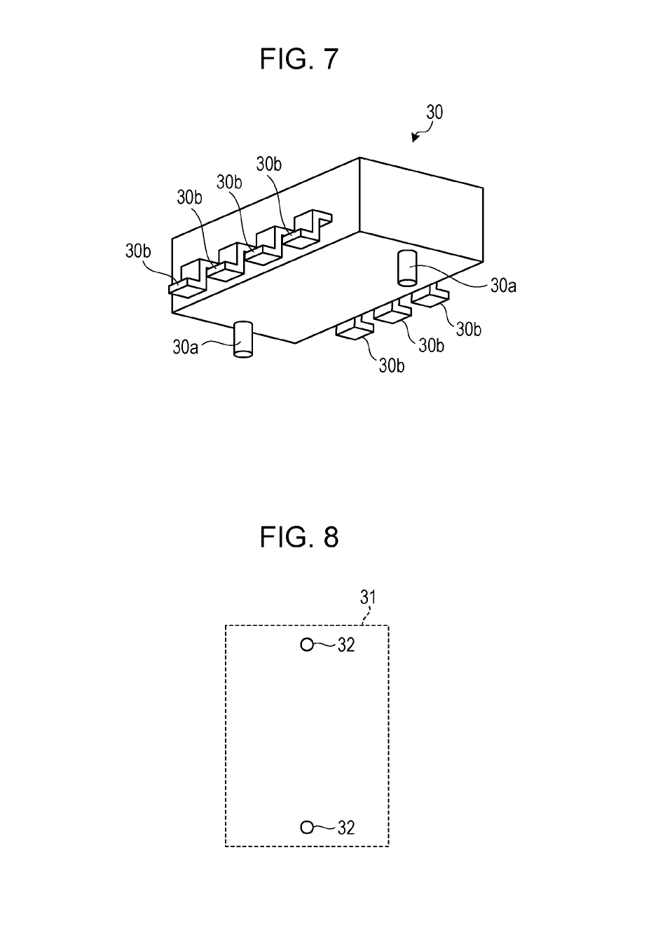

The extraction unit 15b then determines whether or not the value obtained by dividing the total area by the area of the projected region (the total area/the area of the projected region) is smaller than a predetermined value, for example, 0.1. FIGS. 7 and 8 are illustrations each depicting an example of processing performed by the design support apparatus according to the first embodiment. The example of FIG. 7 illustrates an electronic part model 30 which has a boss 30a for positioning. In the example of FIG. 7, the surface on which the boss 30a lies has terminals 30b to be mounted on a footprint. That is to say, in the example of FIG. 7, the surface on which the boss 30 lies is the mounting surface. Here, as illustrated in FIG. 8, shapes 32 of the part model 30 in the outermost plane 31 on which the boss 30 lies are the end portions of the boss 30a. Thus, when the shapes 32 as illustrated in FIG. 8 are extracted as the shape of the part model, the surface on which the boss 30 lies is not determined as the mounting surface by the below-described determination unit 15c because of what is described in detail below. This is because the shape of the part model in the outermost plane, which is obtained due to the existence of a projection such as the boss 30a, is inappropriate as the shape to be used for determining the mounting surface.

The extraction unit 15b then ignores any shape which is inappropriate as the shape to be used for determining the mounting surface by using the fact that the area of the shape of the part model in the outermost plane, which is obtained due to such a projection is significantly smaller than the area of the projected region. That is to say, when the value obtained by dividing the total area by the area of the projected region is smaller than a predetermined value, the acquired shape is inappropriate as the shape to be used for determining the mounting surface, and thus the extraction unit 15b moves the outermost plane inward by a predetermined distance, and acquires the shape of the part model again. An example of such a predetermined distance is 1 mm. The extraction unit 15b then calculates the area of each shape, and the total area in the moved outermost plane similarly to the above-described method. The extraction unit 15b repeats the process of moving the outermost plane inward and acquiring the shape of the part model in the moved outermost plane until (the total area/the area of the projected region) becomes smaller than a predetermined value. FIG. 9 is an illustration depicting an example of an acquired characteristic. As a result of ignoring the shape of the part model in an inappropriate outermost plane such as described above, the extraction unit 15b acquires shapes 33 corresponding to the terminals 30b as the shape of the part model 30 in the outermost plane 31 as illustrated in the example of FIG. 9.

In addition, the extraction unit 15b calculates the number of shapes for each of the outermost planes. In the example of FIG. 6, the number of shapes included in the closed shape 29a in the outermost plane 28a is calculated to be 1 by the extraction unit 15b. In the example of FIG. 6, the number of shapes included in the closed shapes 29b in the outermost plane 28b is calculated to be 8 by the extraction unit 15b. In the example of FIG. 6, the number of shapes included in the closed shapes 29c in the outermost plane 28c is calculated to be 4 by the extraction unit 15b. In the example of FIG. 6, the number of shapes included in the closed shapes 29d in the outermost plane 28d is calculated to be 4 by the extraction unit 15b. In the example of FIG. 6, the number of shapes included in the closed shape 29e in the outermost plane 28e is calculated to be 1 by the extraction unit 15b. In the example of FIG. 6, the number of shapes included in the closed shape 29f in the outermost plane 28f is calculated to be 1 by the extraction unit 15b.

The extraction unit 15b then calculates the distance between shapes for each of the outermost planes. In the example of FIG. 6, for the shapes included in each of the shapes 29a to 29f of the outermost planes 28a to 28f, the extraction unit 15b calculates the distance between each shape and the closest shape thereto.

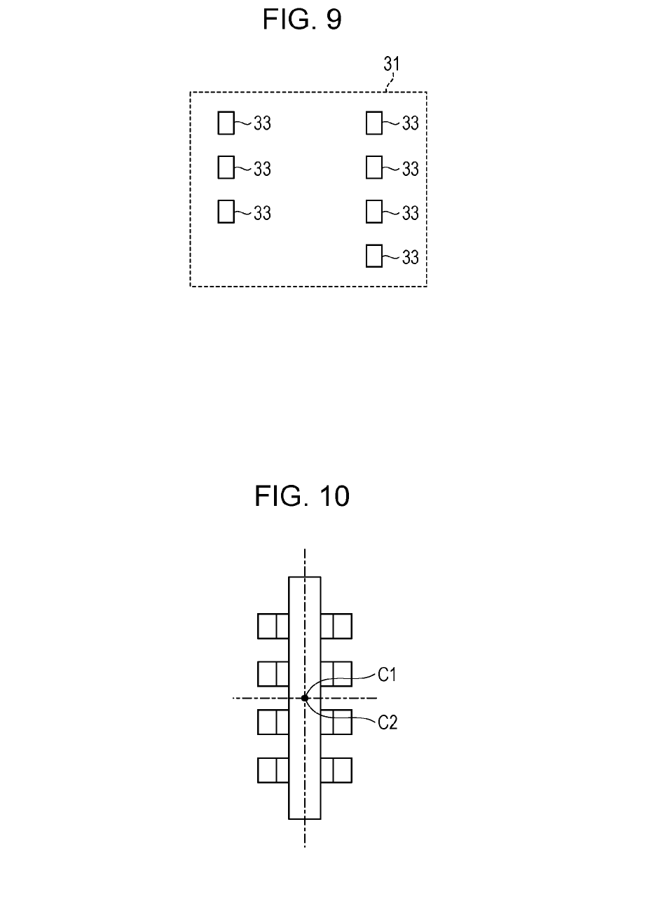

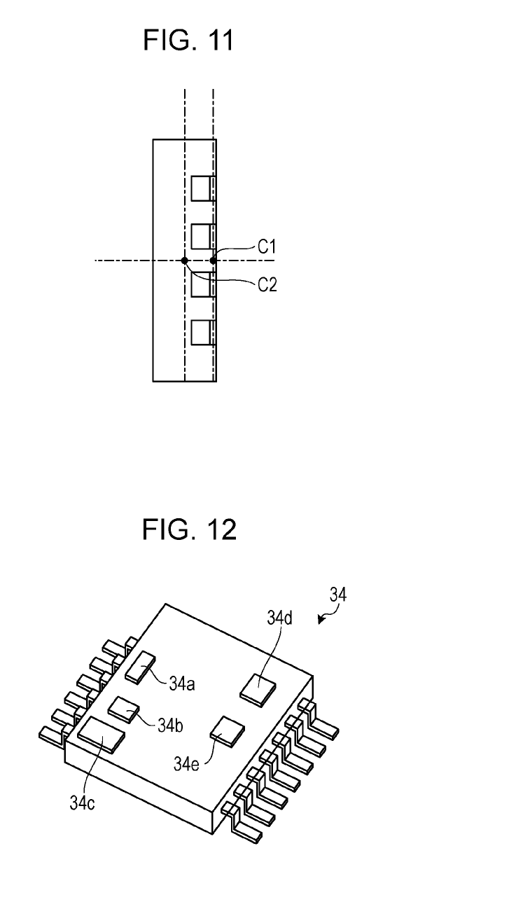

Subsequently, the extraction unit 15b calculates the center position of the shapes for each of the outermost planes. The extraction unit 15b then calculates the center position of the projected region for each of the outermost planes. In the example of FIG. 6, the extraction unit 15b calculates the center position of each of the shapes 29a to 29f, and calculates the center position of the projected region of each of the outermost planes 28a to 28f. FIGS. 10 and 11 are illustrations each depicting an example of a center position. The example of FIG. 10 illustrates a center position c1 of the shapes 29b, and a center position c2 of the projected region of the outermost plane 28b. In the example of FIG. 10, the center position c1 and the center position c2 are the same. This is due to the fact that the outermost plane 28b is the mounting surface, and the center position of the shapes on the mounting surface matches the center position of the projected region. The example of FIG. 11 illustrates the center position c1 of the shapes 29d and the center position c2 of the projected region of the outermost plane 28d. In the example of FIG. 11, the center position c1 and the center position c2 are not the same. This is due to the fact that the outermost plane 28d is not the mounting surface.

In the case where the characteristic extracted by the extraction unit 15b satisfies a predetermined condition, the determination unit 15c determines an outermost plane corresponding to the characteristic to be mounted on a printed board model indicated by the second data.

A description is given using a specific example. The determination unit 15c registers the identification information of all the outermost planes to the candidate surface information 14c, the outermost planes being set and defined by the extraction unit 15b.

The determination unit 15c determines pairs of parallel outermost plane from all the outermost planes which are registered in the candidate surface information 14c, and performs the following processing on each pair. That is to say, the determination unit 15c determines whether or not the numbers of the shapes on two outermost planes in the pair are the same. In addition, the determination unit 15c determines whether or not the ratio of the respective total areas on the two outermost planes in the pair is within a predetermined range. Here, in the case where either of the two outermost planes in the pair is the mounting surface, the numbers of the shapes on the two outermost planes in the pair are different. In the case where either of the two outermost planes in the pair is the mounting surface, the respective total areas on the two outermost planes in the pair are significantly different, and the ratio of the two areas does not fall within a predetermined range. Then, in the case where the numbers of the shapes on the two outermost planes in the pair are the same, the determination unit 15c removes the identification information of the two outermost planes in the pair from the candidate surface information 14c because any of the two outermost planes in the pair is not considered to be the mounting surface. In the case where the ratio of the respective total areas on the two outermost planes in the pair is within a predetermined range, for example, within a range of 0.9 to 1.1, the determination unit 15c performs the following processing. That is to say, the determination unit 15c removes the identification information of the two outermost planes in the pair from the candidate surface information 14c because any of the two outermost planes in the pair is not considered to be the mounting surface.

In the example of FIG. 6, the determination unit 15c, as a pair of parallel outermost planes, determines a pair of the outermost planes 28a and 28b, a pair of the outermost planes 28c and 28d, and a pair of the outermost planes 28e and 28f. In the example of FIG. 6, the determination unit 15c removes the identification information of the outermost planes 28c, 28d, 28e, 28f from the candidate surface information 14c because the numbers of the respective shapes on the pair of the outermost planes 28c and 28d are the same, and the numbers of the respective shapes on the pair of the outermost planes 28e and 28f are the same.

The determination unit 15c then determines whether or not the number of shapes is plural for each of the outermost planes registered in the candidate surface information 14c. Here, in the case where the number of acquired shapes is one, the outermost plane corresponding to the shape is not considered to be the mounting surface because a plurality of terminals are acquired as the shapes on the outermost plane which is to be the mounting surface. Therefore, in the case where the number of shapes is not plural, i.e., one, the determination unit 15c removes the identification information of the outermost plane corresponding to the shape from the candidate surface information 14c.

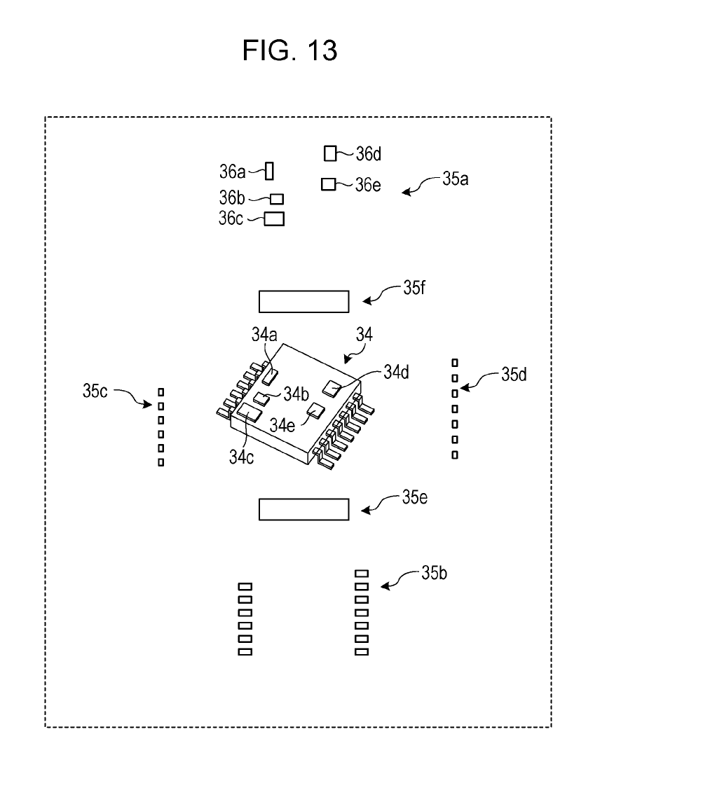

Subsequently, the determination unit 15c determines whether or not the number of outermost planes registered in the candidate surface information 14c is one. When the number of outermost planes is one, the determination unit 15c determines that the outermost plane having the identification information which is registered in the candidate surface information 14c is the mounting surface. When the number of outermost planes is not one, the determination unit 15c performs the following processing for each of the outermost planes registered in the candidate surface information 14c. That is to say, the determination unit 15c determines whether or not all the areas of the shapes which are calculated by the extraction unit 15b are the same, or the areas of partial shapes in a predetermined proportion of the shapes, for example, the areas of half the shapes out of all the shapes are the same. Similarly, the determination unit 15c performs the following processing for each of the outermost planes registered in the candidate surface information 14c. That is to say, the determination unit 15c determines whether or not all the distances between adjacent shapes which are calculated by the extraction unit 15b are the same, or the distances between adjacent shapes in a predetermined proportion of the shapes, for example, the distances between adjacent shapes in half the shapes out of all the shapes are the same. Here, an electronic part model having surfaces on which a plurality of parts are disposed will be described. FIG. 12 is an illustration depicting an example of a part model. The example of FIG. 12 illustrates a part model 34 in which a plurality of parts 34a to 34e are disposed on a surface of the part body. FIG. 13 is an illustration depicting an example of a shape in an outermost plane of the part model in the example of FIG. 12. The example of FIG. 13 illustrates the shapes of the part model 34 in outermost planes 35a to 35f. In the example of FIG. 13, shapes 36a to 36f respectively corresponding to the parts 34a to 34e exist in the outermost plane 35a.

Here, the areas of the terminals of the electronic part on a mounting surface are the same, or the areas of partial terminals in a predetermined proportion of all the terminals on a mounting surface are the same. On the other hand, as illustrated in FIG. 12, the areas of a plurality of parts 34a to 34e disposed on a surface of the part body are all different, or the areas of partial parts in a predetermined proportion of all the parts 34a to 34e are different.

The distance between each terminal and the closest terminal to the terminal is the same for each of all the terminals of the electronic part, or the distances between adjacent terminals in partial terminals of a predetermined proportion of all the terminals are the same. On the other hand, as illustrated in FIG. 12, the parts 34a to 34e disposed on the surface of the part body have different distances there-between, or partial parts in a predetermined proportion of the parts 34a to 34e have different distances there-between.

Then, in the case where not all the areas of the shapes are the same, and not all the areas of partial shapes in a predetermined proportion of the shapes are the same, the determination unit 15c removes the identification information of the outermost planes corresponding to the shapes. In addition, in the case where not all the distances between adjacent shapes are the same, and not all the distances between adjacent shapes of partial shapes in a predetermined proportion of the shapes are the same, the determination unit 15c removes the identification information of the outermost planes corresponding to the shapes.

Subsequently, the determination unit 15c determines whether or not the number of the remaining outermost planes registered in the candidate surface information 14c is one. When the number of outermost planes is one, the determination unit 15c determines that the outermost plane having the identification information which is registered in the candidate surface information 14c is the mounting surface. When the number of outermost planes is not one, the determination unit 15c performs the following processing for each of the outermost planes registered in the candidate surface information 14c. That is to say, the determination unit 15c determines whether or not the center position of the shapes calculated by the extraction unit 15b matches the center position of the projected region. As described above, when the center position of the shapes matches the center position of the projected region, the corresponding outermost plane is considered to be the mounting surface, while when the center position of the shapes does not match the center position of the projected region, the corresponding outermost plane is considered not to be the mounting surface. Then, when the center position of the shapes does not match the center position of the projected region, the determination unit 15c removes the identification information of the outermost plane corresponding to the shapes from the candidate surface information 14c.

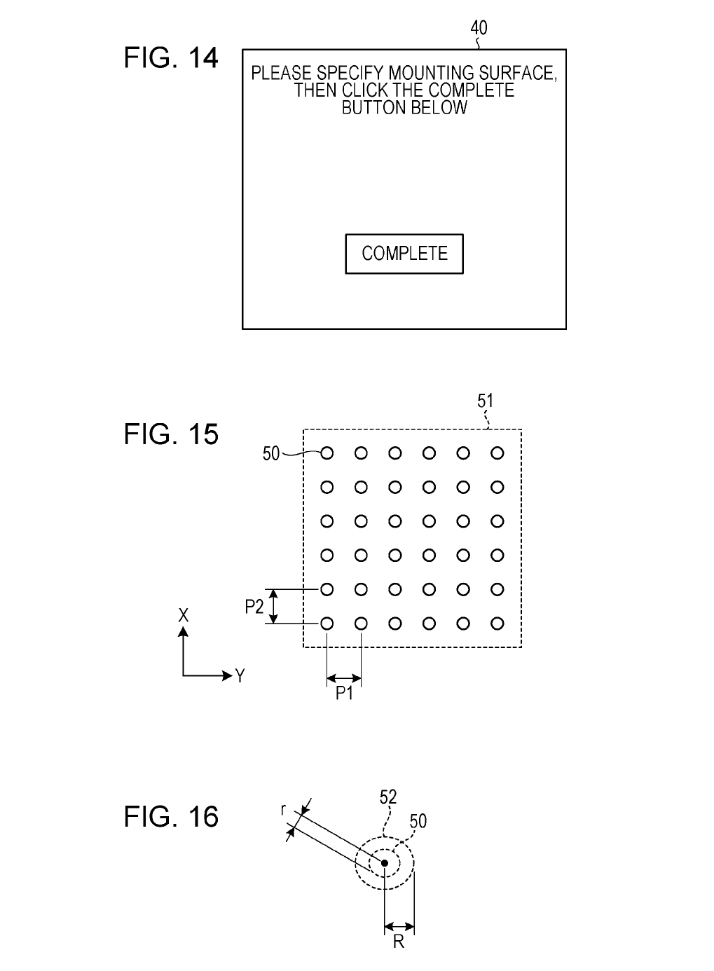

Subsequently, the determination unit 15c determines whether or not the number of the remaining outermost planes registered in the candidate surface information 14c is one. When the number of outermost planes is one, the determination unit 15c determines that the outermost plane having the identification information which is registered in the candidate surface information 14c is the mounting surface. When the number of outermost planes is not one, the determination unit 15c controls the output unit 12 to display a screen for receiving specification of the mounting surface by a user. FIG. 14 is an illustration depicting an example of a screen for receiving specification by a user of a mounting surface. The example of FIG. 14 illustrates a window 40 on the display screen of the output unit 12, the window 40 being configured to receive specification of the mounting surface by a user. In the example of FIG. 14, the window 40 and the part model (not illustrated) are displayed on the display screen of the output unit 12. In the case of this example, each surface of the part model may be specified by a user. When either one of the surfaces of the part model is specified as the mounting surface, and a complete button is pressed by a user, the determination unit 15c determines the surface specified by the user to be the mounting surface.

As described above, the acquisition unit 15a acquires the first data and the second data from the mechanical CAD system 20 and the printed board CAD system 21, respectively. The extraction unit 15b then extracts characteristics of the part model in a plurality of outermost planes of the part model on a plane-by-plane basis. The determination unit 15c then determines an outermost plane to be mounted on a printed board model indicated by the second data in the case where the extracted characteristic satisfies a predetermined condition, the outermost plane corresponding to the characteristic. In this manner, the design support apparatus 10 determines a surface of the part model by automatic processing, the surface being mounted on the printed board model. Therefore, with the design support apparatus 10, a time for a user or the like to determine a surface of the part model is saved, the surface being mounted on the printed board model, and thus CAD data may be cooperatively coordinated easily.

The generation unit 15d generates a footprint for mounting the part model on the printed board model, based on the characteristic of the outermost plane determined by the determination unit 15c as the surface to be mounted on the printed board model.

A description is given using a specific example. The generation unit 15d determines whether or not the shapes in the outermost plane determined as the mounting surface are arranged in a lattice pattern. Here, an example of such a determination method is described. FIG. 15 is an illustration depicting an example of a method for determining whether or not the shapes are arranged in a lattice pattern. The example of FIG. 15 illustrates the case where the axis corresponding to the longest side of the sides on an outermost plane 51 containing shapes 50 is the X-axis. The example of FIG. 15 illustrates the case where the Y-axis is perpendicular to the X-axis and is on the outermost plane 51. The generation unit 15d counts the respective numbers of the shapes arranged in the X-axis direction and the Y-axis direction, and in the case where the numbers counted on the X-axis and the Y-axis are the same, or the difference between the numbers is smaller than or equal to a predetermined threshold value, the shapes are determined to be arranged in a lattice pattern. In the example of FIG. 15, the number of the shapes 50 in the X-axis direction is counted to be 6, and the number of the shapes 50 in the Y-axis direction is counted to be 6 by the generation unit 15d. In the example of FIG. 15, the generation unit 15d determines that the shapes are arranged in a lattice pattern because the numbers counted on the X-axis and the Y-axis are the same. On the other hand, in the case where the difference between the numbers counted on the X-axis and the Y-axis is larger a predetermined threshold value, the generation unit 15d determines that the shapes are not arranged in a lattice pattern.

In the case where the shapes are determined to be arranged in a lattice pattern, the generation unit 15d enlarges the shapes uniformly in consideration of an interval between adjacent shapes so that adjacent shapes are not overlapped with each other when all the shapes are enlarged. FIG. 16 is an illustration depicting an example of processing performed by the design support apparatus according to the first embodiment. For example, in the example of FIG. 15, the interval between the shapes 50 in the X-axis direction is P2, and the interval between the shapes 50 in the Y-axis direction is P1. Thus, the generation unit 15d determines the shorter interval between P1 and P2, and calculates the value of radius R for each shape 50 to be smaller than half the value of the determined P1 or P2 so that adjacent shapes 50 are not overlapped with each other when the shapes 50 are enlarged. However, the value of radius R is larger than radius r of the shape 50. The generation unit 15d defines a circle 52 with the calculated radius R as the footprint. By performing such processing on all the shapes, the generation unit 15d generates footprints.

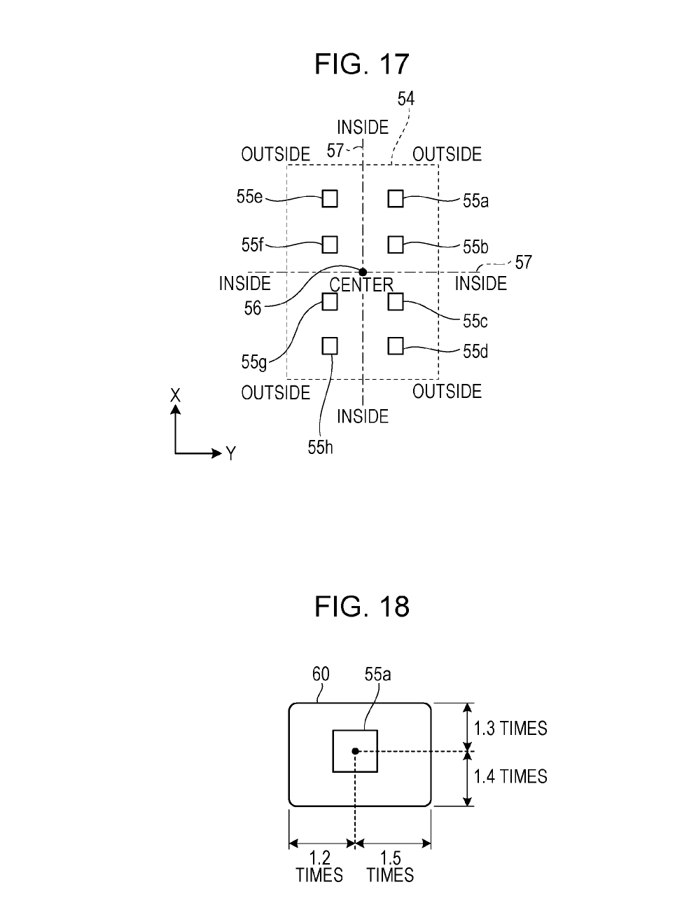

On the other hand, in the case where the shapes are determined not to be arranged in a lattice pattern, the generation unit 15d enlarges each shape with an enlargement ratio varied depending on the inside and the outside of the shapes. FIGS. 17 and 18 are illustrations each depicting an example of processing performed by the design support apparatus according to the first embodiment. For example, in the example of FIG. 17, the generation unit 15d detects a center position 56 of an outermost plane 54, thereby extracting a center line 57 for defining the inside and the outside of the outermost plane 54. The generation unit 15d detects the outside and the inside in the X-axis direction, and the outside and the inside in the Y-axis direction by using the center line 57 for each of shapes 55a to 55h. The generation unit 15d enlarges each of the shapes 55a to 55h with an enlargement ratio corresponding to each combination of the outside and the inside in the X-axis direction, and the outside and the inside in the Y-axis direction, and defines an enlarged shape 60 as the footprint. The example of FIG. 18 illustrates an example of an enlargement method for the shape 55a. In the example of FIG. 18, in the inside in the Y-axis direction, the shape 55a is enlarged with a first enlargement ratio, for example, 1.2 times, and in the outside in the Y-axis direction, the shape 55a is enlarged with a second enlargement ratio, for example, 1.5 times. In the example of FIG. 18, in the inside in the X-axis direction, the shape 55a is enlarged with a third enlargement ratio, for example, 1.4 times, and in the outside in the X-axis direction, the shape 55a is enlarged with a fourth enlargement ratio, for example, 1.3 times. The generation unit 15d defines the enlarged shape 60 as the footprint. By performing such processing on all the shapes, the generation unit 15d generates footprints.

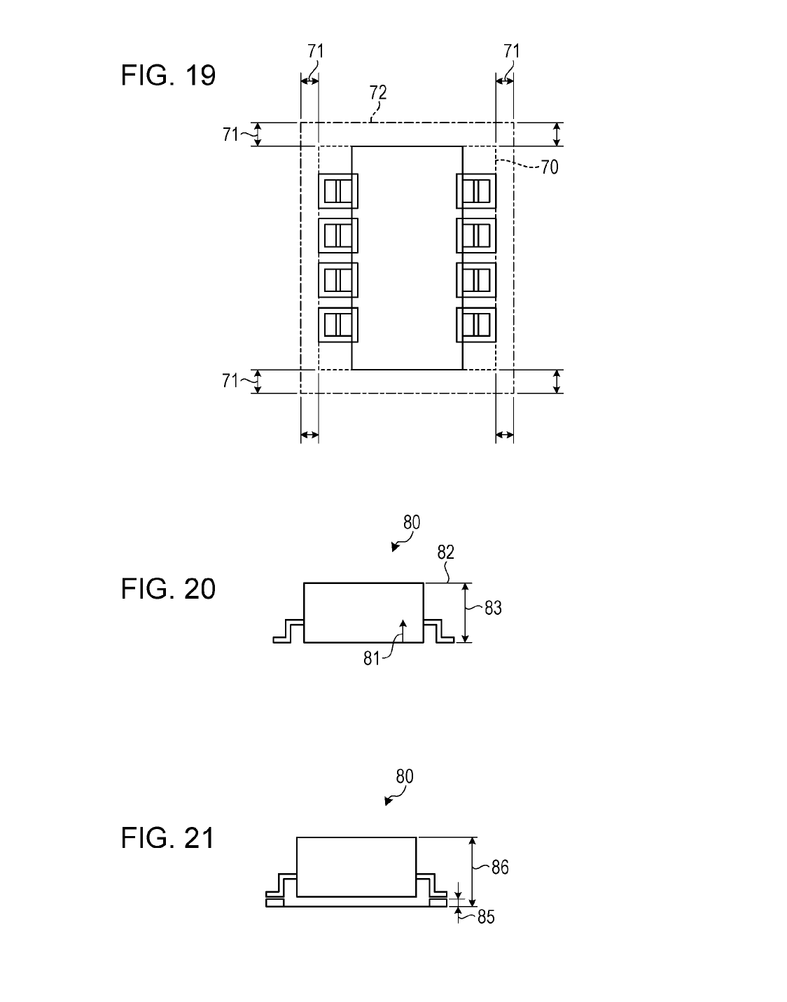

In addition, the generation unit 15d determines a part mounting region. A specific example will be described. FIG. 19 is an illustration depicting an example of processing performed by the design support apparatus according to the first embodiment. The generation unit 15d acquires line drawing information obtained when the electronic part model is projected on the outermost plane which is determined as the mounting surface. The generation unit 15d then combines the shape of the generated footprint with the line drawing information, and generates the combined region as the part shape region. In the example of FIG. 19, the generation unit 15d generates a part shape region 70. The generation unit 15d then defines and determines a region as the part mounting region, the region being obtained by adding the tolerance of the part contour and known amount of displacement to the part shape region 70, the displacement being caused when the electronic part is mounted on the printed board. In the example of FIG. 19, the generation unit 15d defines and determines a part mounting region 72 which is obtained in consideration of the tolerance and an amount of displacement 71. In the part shape region 70 and the part mounting region 72, various regions which are used when an electronic part is arranged on the printed board, for example, a handling space used when a part is mounted, a mounting prohibited region of other parts, and the like may be defined.

In addition, the generation unit 15d determines the height of an electronic part model. A specific example will be described. FIG. 20 is an illustration depicting an example of processing performed by the design support apparatus according to the first embodiment. The example of FIG. 20 illustrates a part model 80. In the example of FIG. 20, the generation unit 15d detects an opposite direction 81 which is opposite to the mounting direction for an electronic part model. In the example of FIG. 20, the generation unit 15d detects an outermost position 82 of the part model 80 in the detected opposite direction 81. Subsequently, in the example of FIG. 20, the generation unit 15d determines, as the height of the part model, a distance 83 between the detected outermost position 82 and the mounting surface of the printed board model. Here, a case will be described where a thickness of solder material which is used for connecting the terminals of the part model to a footprint on the printed board model is taken into consideration. FIG. 21 is an illustration depicting an example of processing performed by the design support apparatus according to the first embodiment. In the example of FIG. 21, the generation unit 15d determines a value as a height 86 of the part model 80, the value being obtained by adding a thickness 85 of solder material to the distance 83.

The arrangement unit 15e mounts the terminals of a mounting surface on a footprint on a printed board model, the mounting surface being determined by the determination unit 15c, and the printed board model being generated by the generation unit 15d, thereby generating a combination model which is obtained by combining the part model with the printed board model.

The arrangement unit 15e then controls the output unit 12 to display the generated combination model.

The control unit 15 is an integrated circuit such as an ASIC (Application Specific Integrated Circuit) or an FPGA (Field Programmable Gate Array), or an electronic circuit such as a CPU (Central Processing Unit) or an MPU (Micro Processing Unit).

[Flow of Processing]

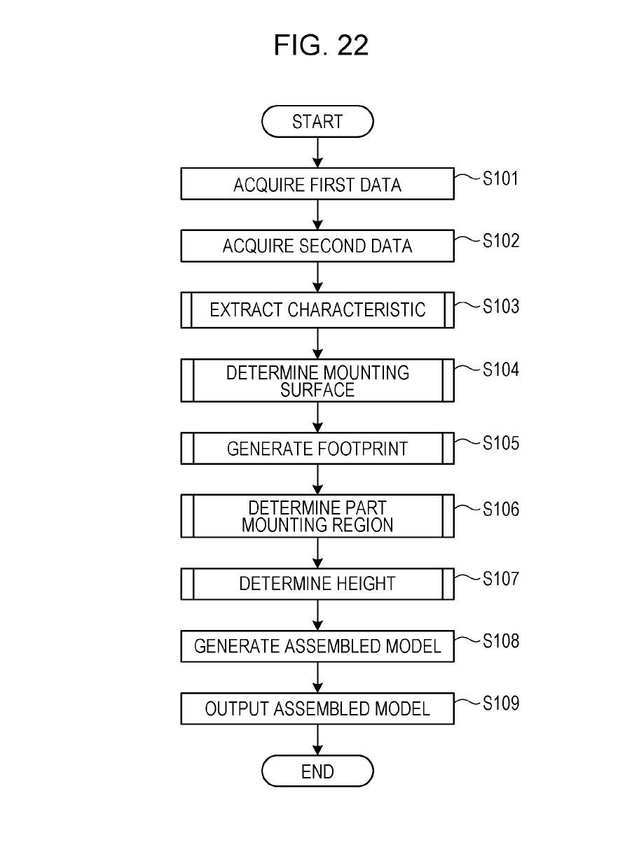

Next, the flow of processing performed by the design support apparatus 10 according to the present embodiment will be described. FIG. 22 is a method illustrating the steps of cooperative processing according to the first embodiment. An example of timing at which cooperative processing is performed is a moment when the control unit 15 receives a command for performing cooperative processing from a user via the input unit 11.

As illustrated in FIG. 22, the acquisition unit 15a acquires the first data (S101). The acquisition unit 15a acquires the second data (S102). Subsequently, the extraction unit 15b performs the below-described characteristic extraction processing (S103). Subsequently, the determination unit 15c performs the below-described mounting surface determination processing (S104). The generation unit 15d then performs the below-described footprint generation processing (S105). Subsequently, the generation unit 15d performs the below-described part mounting region determination processing (S106). Subsequently, the generation unit 15d performs the below-described height determination processing (S107). The arrangement unit 15e then generates a combination model (S108). Subsequently, the arrangement unit 15e controls the output unit 12 to display the generated combination model (S109).

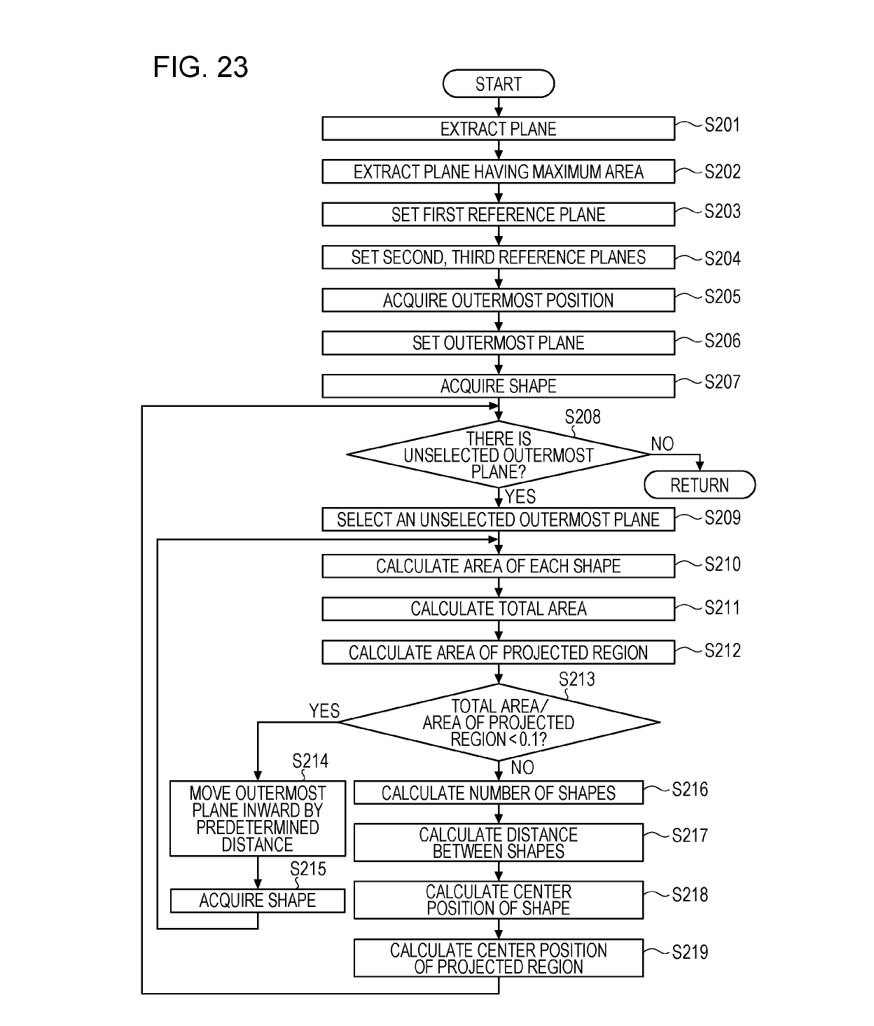

Next, the characteristic extraction processing will be described. FIG. 23 is a method illustrating the steps of characteristic extraction processing according to the first embodiment.

As illustrated in FIG. 23, the extraction unit 15b extracts a plurality of surfaces of the electronic part model indicated by the first data which is acquired from the first DB 14a by the acquisition unit 15a (S201). The extraction unit 15b extracts a surface with the largest area from the extracted plurality of surfaces (S202). Subsequently, the extraction unit 15b sets and defines the plane containing the extracted surface with the largest area as a first reference plane (S203).

The extraction unit 15b then sets and defines a second reference plane and a third reference plane which are perpendicular to each other, and are perpendicular to the first reference plane 24 (S204). Subsequently, the extraction unit 15b acquires a plurality of outermost positions of the electronic part model based on the first data (S205).

Then, for each of the acquired outermost positions, the extraction unit 15b sets and defines an outermost plane which is parallel to either one of the first reference plane, the second reference plane, and the third reference plane (S206).

The extraction unit 15b acquires a closed shape on each of the outermost planes of the part model (S207). Subsequently, the extraction unit 15b determines whether or not there is an unselected outermost plane in the below-described S209 (S208). When there is no unselected outermost plane (“No” in S208), the extraction unit 15b stores a result of processing into an internal memory of the control unit 15, and the process is terminated. On the other hand, when there is an unselected outermost plane (“Yes” in S208), the extraction unit 15b selects an unselected outermost plane (S209). The extraction unit 15b the calculates the area of each shape in the selected outermost plane (S210).

Subsequently, the extraction unit 15b calculates the total of the calculated area of each shape (S211). Subsequently, the extraction unit 15b projects the part model on the selected outermost plane, and calculates the area of projected region (S212). The extraction unit 15b then determines whether or not the value obtained by dividing the total area by the area of the projected region (the total area/the area of the projected region) is smaller than a predetermined value, for example, 0.1 (S213).

When the value obtained by dividing the total area by the area of the projected region is smaller than a predetermined value (“Yes” in S213), the extraction unit 15b moves the outermost plane inward by a predetermined distance (S214). The extraction unit 15b again acquires the shape of the part model in the moved outermost plane (S215), and the process returns to S210.

On the other hand, when the value obtained by dividing the total area by the area of the projected region is larger than or equal to a predetermined value (“No” in S213), the extraction unit 15b calculates the number of shapes in the selected outermost plane (S216).

The extraction unit 15b calculates the distances between adjacent shapes in the selected outermost plane (S217). Subsequently, the extraction unit 15b calculates the center position of the shapes in the selected outermost plane (S218). The extraction unit 15b calculates the center position of the projected region in the selected outermost plane (S219), and the process returns to S208.

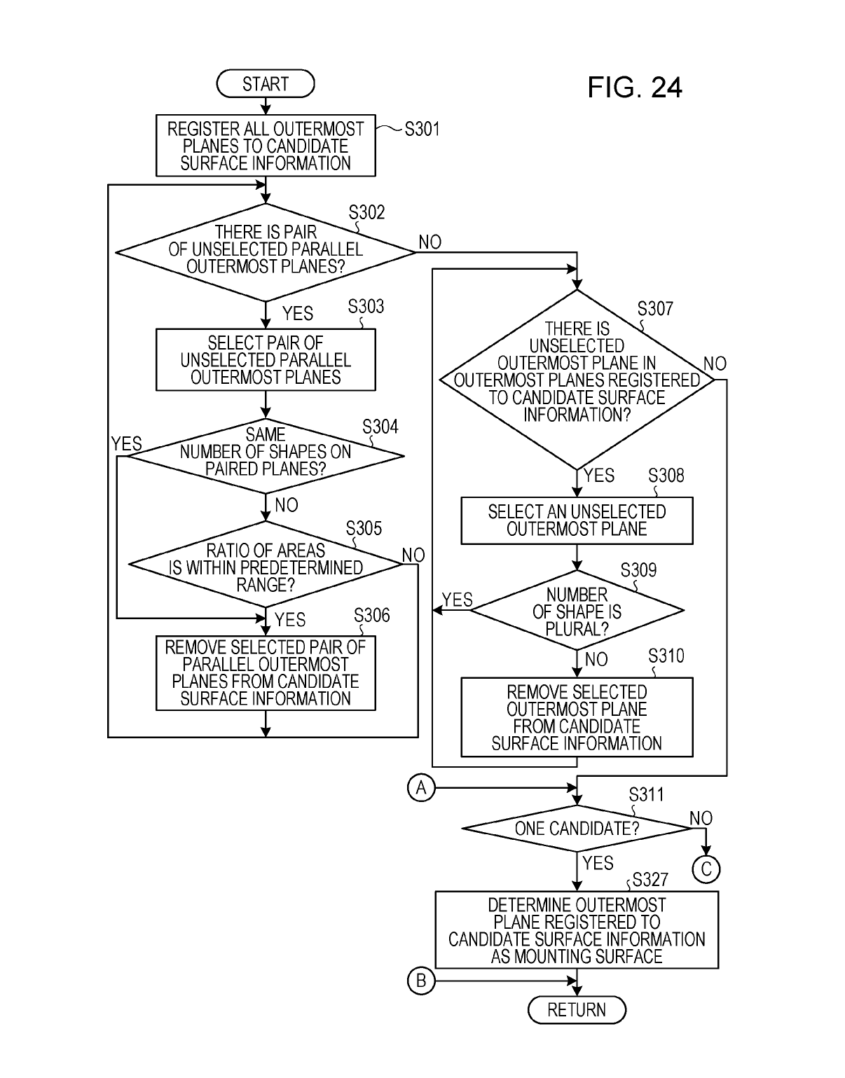

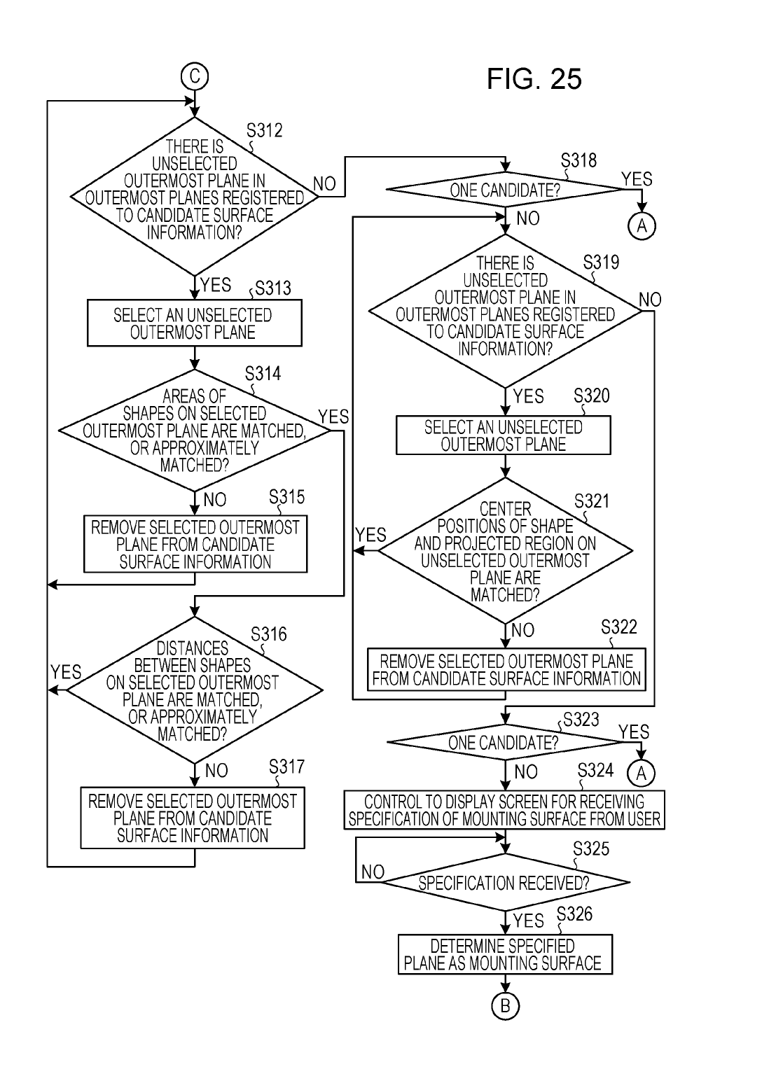

Next, the mounting surface determination processing will be described. FIGS. 24 and 25 are methods each illustrating the steps of the mounting surface determination processing according to the first embodiment.

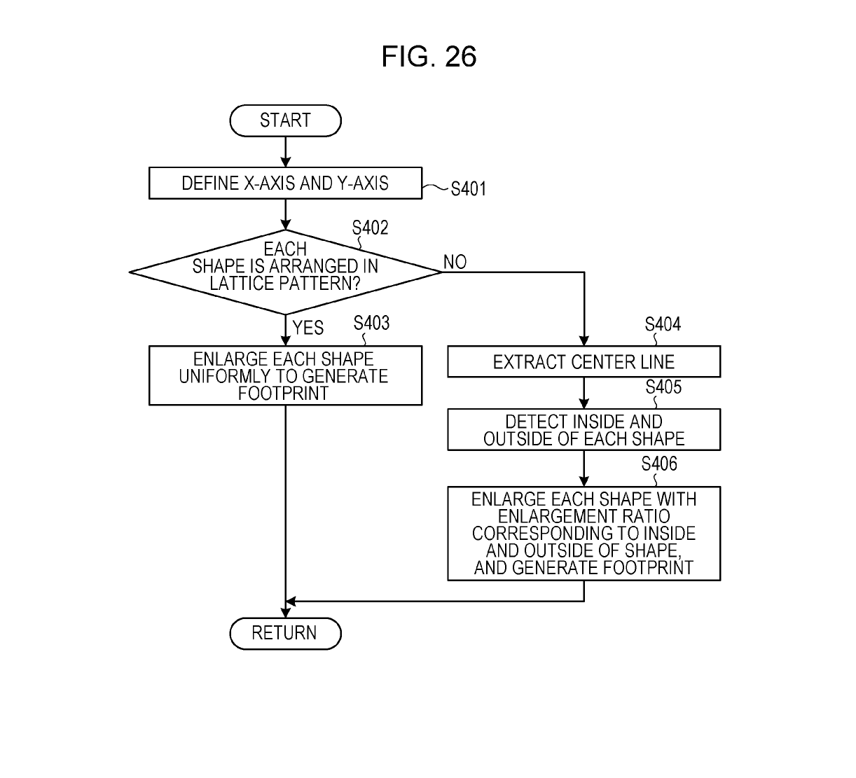

As illustrated in FIG. 26, the determination unit 15c registers the identification information of all the outermost planes to the candidate surface information 14c, the identification information being set and defined by the extraction unit 15b (S301). The determination unit 15c then determines pairs of parallel outermost plane from all the outermost planes which are registered in the candidate surface information 14c, and determines whether or not there is any unselected pair in the below-described S303 (S302). When there is an unselected pair (“Yes” in S302), the determination unit 15c selects an unselected pair (S303). Subsequently, the determination unit 15c determines whether or not the numbers of the shapes on two outermost planes in the selected pair are the same (S304). When the numbers are the same (“Yes” in S304), the determination unit 15c removes the identification information of the two outermost planes in the pair from the candidate surface information 14c (S306), and the process returns to S302. On the other hand, when the numbers are not the same (“No” in S304), the determination unit 15c determines whether or not the ratio of the respective total areas on the two outermost planes in the pair is within a predetermined range (S305). When the ratio of the total areas is within a predetermined range (“Yes” in S305), the process proceeds to S306. When the ratio of the total areas is not within a predetermined range (“No” in S305), the process returns to S302.

On the other hand, when there is no unselected pair (“No” in S302), the determination unit 15c determines whether or not there is an unselected outermost plane in the below-described S308 in the outermost planes which are registered in the candidate surface information 14c (S307). When there is an unselected outermost plane (“Yes” in S307), the determination unit 15c selects an unselected outermost plane (S308). Subsequently, the determination unit 15c determines whether or not the number of the shapes on the selected outermost plane is plural (S309). When the number of shape is not plural (“No” in S309), the determination unit 15c removes the identification information of the outermost plane corresponding to the shape from the candidate surface information 14c (S310), and the process returns to S307. When the number of shape is plural (“Yes” in S309), the flow also returns to S307.

On the other hand, when there is no unselected outermost plane (“No” in S307), the determination unit 15c determines whether or not the number of the outermost planes registered in the candidate surface information 14c is one (S311). When the number of outermost planes is one (“Yes” in S311), the determination unit 15c determines that the outermost plane having the identification information which is registered in the candidate surface information 14c is the mounting surface (S327), stores a result of processing into the internal memory of the control unit 15, and the process is terminated. On the other hand, when the number of outermost planes is not one (“No” in S311), the determination unit 15c determines whether or not there is an unselected outermost plane in the below-described S313 in the outermost planes which are registered in the candidate surface information 14c (S312). When there is an unselected outermost plane (“Yes” in S312), the determination unit 15c selects an unselected outermost plane (S313). Subsequently, for the selected outermost plane, the determination unit 15c determines whether or not all the areas of the shapes, which are calculated by the extraction unit 15b are the same, or the areas of partial shapes in a predetermined proportion of the shapes are the same (S314). When not all the areas are the same, and not all areas of partial shapes in a predetermined proportion of the shapes are the same (“No” in S314), the determination unit 15c removes the identification information of the outermost plane corresponding to the shapes from the candidate surface information 14c (S315), and the process returns to S312.

When all the areas are the same, or the areas of partial shapes in a predetermined proportion of the shapes are the same (“Yes” in S314), the determination unit 15c performs the following processing. That is to say, for the selected outermost plane, the determination unit 15c determines whether or not all the distances between adjacent shapes, which are calculated by the extraction unit 15b are the same, or the distances between adjacent shapes in a predetermined proportion of the shapes are the same. (S316). When not all the distances between adjacent shapes are the same, and not all the distances between adjacent shapes of partial shapes in a predetermined proportion of the shapes are the same (“No” in S316), the determination unit 15c removes the identification information of the outermost planes corresponding to the shapes (S317), and the process returns to S312. When all the distances between adjacent shapes are the same, or all the distances between adjacent shapes of partial shapes in a predetermined proportion of the shapes are the same (“Yes” in S316), the flow also returns to S312.

On the other hand, when there is no unselected outermost plane (“No” in S312), the determination unit 15c determines whether or not the number of the outermost planes registered in the candidate surface information 14c is one (S318). When the number of outermost planes is one (“Yes” in S318), the process proceeds to S327. On the other hand, when the number of outermost planes is not one (“No” in S318), the determination unit 15c determines whether or not there is an unselected outermost plane in the below-described S320 in the outermost planes which are registered in the candidate surface information 14c (S319). When there is an unselected outermost plane (“Yes” in S319), the determination unit 15c selects an unselected outermost plane (S320). Subsequently, for the selected outermost plane, the determination unit 15c determines whether or not the center position of the shapes calculated by the extraction unit 15b matches the center position of the projected region (S321). When the center position of the shapes does not match the center position of the projected region (“No” in S321), the determination unit 15c removes the identification information of the outermost plane corresponding to the shapes from the candidate surface information 14c (S322), and the process returns to S319. When the center position of the shapes matches the center position of the projected region (“Yes” in S321), the process also returns to S319.

On the other hand, when there is no unselected outermost plane (“No” in S319), the determination unit 15c determines whether or not the number of the outermost planes registered in the candidate surface information 14c is one (S323). When the number of outermost planes is one (“Yes” in S323), the process proceeds to S327. On the other hand, when the number of outermost planes is not one (“No” in S323), the determination unit 15c controls the output unit 12 to display a screen for receiving specification of the mounting surface by a user (S324). The determination unit 15c then determines whether or not either one of the surfaces of the part model has been specified as the mounting surface, and a complete button has been pressed by a user (S325).

When the complete button has not been pressed (“No” in S325), the determination unit 15c makes a similar determination again in S325. On the other hand, when the complete button has been pressed (“Yes” in S325), the determination unit 15c determines the surface specified by a user as the mounting surface (S326), stores a result of processing into the internal memory of the control unit 15, and the process is terminated.

Next, the footprint generation processing will be described. FIG. 26 is a method illustrating the steps of footprint generation processing according to the first embodiment.

As illustrated in FIG. 26, the generation unit 15d defines the X-axis and the Y-axis (S401). The generation unit 15d then determines whether or not the shapes in the outermost plane determined as the mounting surface are arranged in a lattice pattern (S402).

When the shapes are arranged in a lattice pattern (“Yes” in S402), the generation unit 15d enlarges the shapes uniformly in consideration of an interval between adjacent shapes so that adjacent shapes are not overlapped with each other when all the shapes are enlarged (S403). The generation unit 15d then stores a result of processing into the internal memory of the control unit 15, and the process is terminated.

On the other hand, when the shapes are not arranged in a lattice pattern (“No” in S402), the generation unit 15d detects the center position of the outermost plane, thereby extracting the center line for defining the inside and the outside of the outermost plane (S404). The generation unit 15d then detects the outside and the inside in the X-axis direction, and the outside and the inside in the Y-axis direction by using the center line for each shape (S405). The generation unit 15d then enlarges each shape with an enlargement ratio corresponding to each combination of the outside and the inside in the X-axis direction, and the outside and the inside in the Y-axis direction, and defines the enlarged shape as the footprint (S406). The generation unit 15d then stores a result of processing into the internal memory of the control unit 15, and the process is terminated.

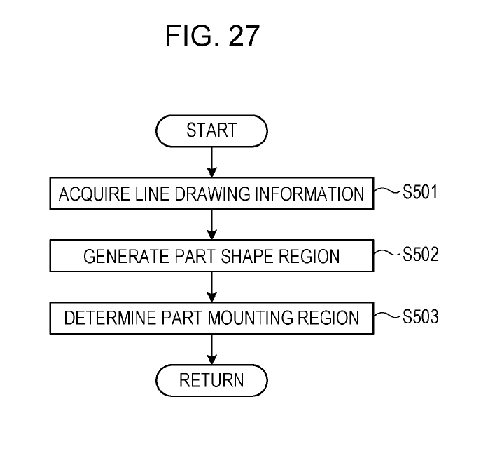

Next, the part mounting region determination processing will be described. FIG. 27 is a method illustrating the steps of part mounting region determination processing according to the first embodiment.

As illustrated in FIG. 27, the generation unit 15d acquires line drawing information obtained when the electronic part model is projected on the outermost plane which is determined as the mounting surface (S501). The generation unit 15d then combines the shape of the generated footprint with the line drawing information, and generates the combined region as the part shape region (S502). The generation unit 15d then defines and determines a region as the part mounting region, the region being obtained by adding the tolerance of the part contour and known amount of displacement to the part shape region, the displacement being caused when the electronic part is mounted on the printed board (S503). The generation unit 15d then stores a result of processing into the internal memory of the control unit 15, and the process is terminated.

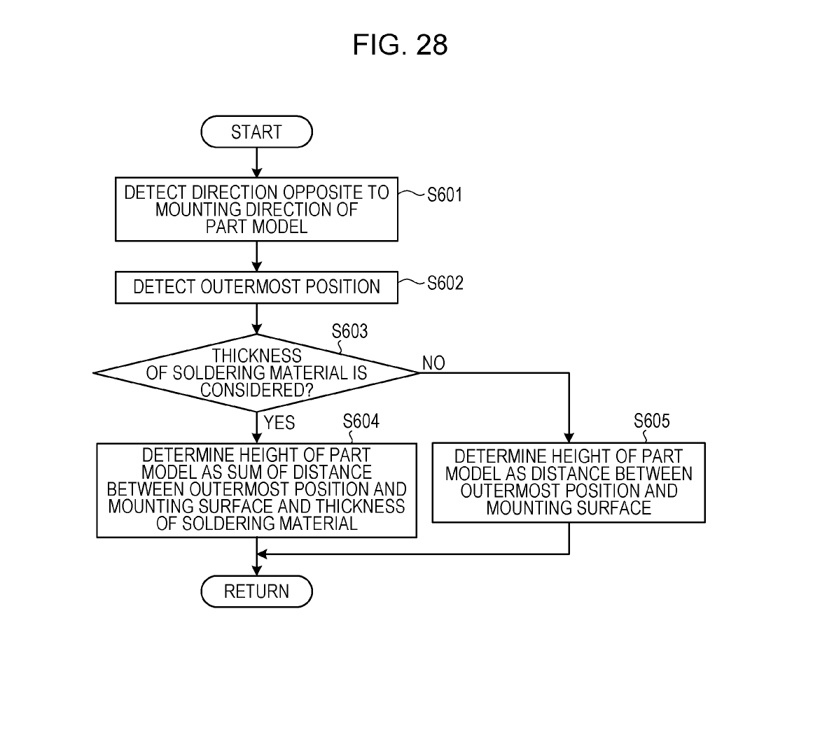

Next, the height determination processing will be described. FIG. 28 is a method illustrating the steps of height determination processing according to the first embodiment.

As illustrated in FIG. 27, the generation unit 15d detects an opposite direction which is opposite to the mounting direction for the electronic part model (S601). The generation unit 15d then detects the outermost position of the part model in the detected opposite direction (S602). Subsequently, the generation unit 15d, when determining the height of the part model, determines whether or not a thickness of solder material is taken into consideration (S603). When a thickness of solder material is not taken into consideration (“No” in S603), the generation unit 15d determines, as the height of the part model, the distance between the detected outermost position and the mounting surface of the printed board model (S605). The generation unit 15d then stores a result of processing into the internal memory of the control unit 15, and the process is terminated. On the other hand, when a thickness of solder material is taken into consideration (“Yes” in S603), the generation unit 15d determines a value as the height of the part model, the value being obtained by adding the thickness of solder material to the distance between the outermost position and the mounting surface of the printed board model (S604). The generation unit 15d then stores a result of processing into the internal memory of the control unit 15, and the process is terminated.

As described above, the design support device 10 according to the present embodiment acquires the first data and the second data from the mechanical CAD system 20 and the printed board CAD system 21, respectively. In addition, the design support device 10 according to the present embodiment extracts characteristics of the part model in a plurality of outermost planes of the part model on a plane-by-plane basis. In addition, the design support device 10 according to the present embodiment determines an outermost plane to be mounted on the printed board model indicated by the second data in the case where the extracted characteristic satisfies a predetermined condition, the outermost plane corresponding to the characteristic. In this manner, the design support device 10 according to the present embodiment determines a surface of the part model by automatic processing, the surface being mounted on the printed board model. Therefore, with the design support apparatus 10 according to the present embodiment, a time for a user or the like to determine a surface of the part model is saved, the surface being mounted on the printed board model, and thus CAD data may be cooperatively coordinated easily.

So far, the embodiment of the disclosed apparatus has been described, however, the present disclosure may be practiced in various different embodiments in addition to the above-described embodiment. Thus, other embodiments included in the present disclosure will be described in the following.

For example, in the first embodiment, a case has been described where the design support device 10 is a device separated from the mechanical CAD system 20 and the printed board CAD system 21. However, the disclosed design support apparatus 10 may be incorporated into the mechanical CAD system 20 or the printed board CAD system 21.

In the processing described in the first embodiment, all or part of the processing which has been described as automatic processing may be manually performed. In the processing described in the present embodiment, all or part of the processing which has been described as manual processing may be automatically performed by a publicly known method.

According to various types of loads and status of use, sub-processing in each step of each processing described in the embodiment may be further arbitrarily divided, or may be combined. In addition, some steps may be omitted. For example, the processing in S312 to S317 may be omitted.

According to various types of loads and status of use, the order of processing in each step of each processing described in the embodiment may be changed. For example, before the processing in S312 to S317 are performed, the processing in S318 to S326 may also be performed.

Each component of each device illustrated is functionally conceptual, and may not be physically configured as illustrated. That is to say, the specific state of distribution or integration of the devices is not limited to what is illustrated, and a configuration may be adopted such that all or part of the devices are functionally or physically distributed, integrated in arbitrary units according to various types of loads and status of use. For example, the generation unit 15d and the arrangement unit 15e illustrated in FIG. 1 may be integrated.

[Design Support Program]

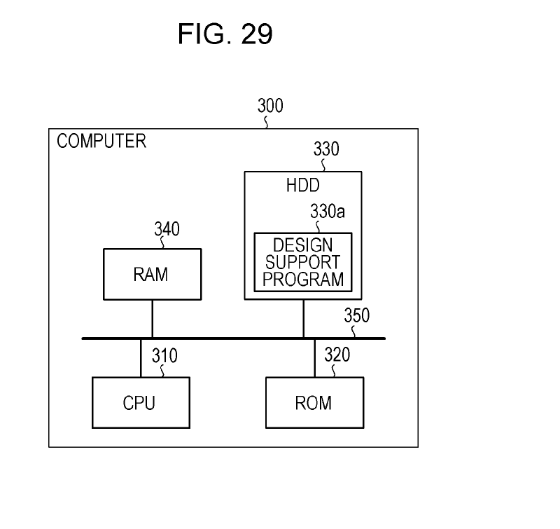

Various types of processing of the design support apparatus 10 described in the above embodiment may be achieved by executing a previously prepared program on a computer system such as a personal computer or a workstation. Now, in the following, an exemplary computer which executes a design support program will be described with reference to FIG. 29, the design support program having a function similar to that of the design support apparatus 10 described in the above embodiment. FIG. 29 is a diagram illustrating a computer for executing a design support program.

As illustrated in FIG. 29, a computer 300 includes a CPU (Central Processing Unit) 310, a ROM(Read Only Memory) 320, a HDD (Hard Disk Drive) 330, and a RAM (Random Access Memory) 340. These components 310 to 340 are connected to each other via a bus 350. The CPU 310 is an example of the control unit 15 described above. The ROM 320, HDD 330, and RAM 340 are examples of the storage unit 14 described above.

ROM 320 stores an OS (Operating System) program and the like.

HDD 330 previously stores a design support program 330a which has functions similar to those of the acquisition unit 15a, the extraction unit 15b, the determination unit 15c, the generation unit 15d, and the arrangement unit 15e illustrated in the above-described first embodiment. The design support program 330a may be divided as appropriate. For example, the design support program 330a may be divided into a program and other program, the program having functions similar to those of the acquisition unit 15a, the extraction unit 15b, and the determination unit 15c, and other program having functions similar to those of the generation unit 15d and the arrangement unit 15e.

HDD 330 includes the first DB, the second DB, and the candidate surface information. The first DB, the second DB, and the candidate surface information respectively correspond to the first DB 14a, the second DB 14b, and the candidate surface information 14c illustrated in FIG. 1.

CPU 310 reads and executes the design support program 330a from HDD 330. In addition, CPU 310 reads the first DB, the second DB, and the candidate surface information, and stores them in RAM 340. CPU 310 executes the design support program 330a using the first DB, the second DB, and the candidate surface information stored in RAM 340. The data stored in RAM 340 may not be all of the data. Only the data used for processing may be stored in RAM 340.

The above-described design support program may not be stored in HDD 330 initially.

For example, the program may be stored in a “portable physical medium” such as a flexible disk (FD), a CD-ROM, a DVD disk, a magneto-optical disk, and an IC card which are to be loaded in the computer 300. The computer 300 may read the program from the above media to execute the program.

Furthermore, the program may be stored in “another computer (or a server) ” which is connected to the computer 300 via a public network, the Internet, LAN, WAN, or the like. The computer 300 may read the program from the above computer or server to execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A design support apparatus comprising:
a processor; and
a memory coupled to the processor, wherein the processor executes a process includes:
acquiring first CAD data that indicates a part model that models a part;
extracting characteristics of the part model from a plurality of outermost planes of the part model on a plane-by-plane basis, the part model being indicated by the first CAD data; and
determining, in the case where the characteristics extracted by the extracting satisfy a certain condition, an outermost plane corresponding to the characteristics as a surface of the part to be mounted on a printed board that is modeled by a printed board model indicated by second CAD data.

2. The design support apparatus according to claim 1,
wherein the determining removes the outermost plane from candidate surfaces to be mounted on the printed board model, the outermost plane corresponding to the characteristics which do not satisfy the certain condition and thereby determines a surface to be mounted on the printed board model from the outermost planes.

3. The design support apparatus according to claim 2,
wherein the extracting extracts a shape and an area of the shape of the part model in the outermost planes on a plane-by-plane basis, and
the determining removes, from the candidate surfaces to be mounted on the printed board, two parallel outermost planes which have the same number of shapes and for which a difference between areas of the shapes is less than a threshold value.

4. The design support apparatus according to claim 2,
wherein the extracting extracts a shape of the part model in the outermost planes on a plane-by-plane basis, and
the determining removes, from the candidate surfaces to be mounted on the printed board model, an outermost plane for which the number of shapes is one.

5. The design support apparatus according to claim 2,
wherein the extracting extracts a shape and an area of the shape of the part model in the outermost planes on a plane-by-plane basis, and
the determining removes, from the candidate surfaces to be mounted on the printed board model, an outermost plane for which distance between the shapes is different, or area of at least some of the shapes out of all the shapes is not same.

6. The design support apparatus according to claim 2,
wherein the extracting extracts, on a plane-by-plane basis, a shape of the part model in the outermost planes and a region of the part model on each of the outermost planes, the region being obtained when the part model is projected on the outermost plane, and
the determining removes, from the candidate surfaces to be mounted on the printed board model, an outermost plane for which a difference between a center position of the shape and a center position of the region is larger than or equal to a threshold value.

7. The design support apparatus according to claim 1, wherein the process further including:
generating a footprint for mounting the part model on the printed board model, based on the characteristics of the outermost plane which is determined by the determining as a surface to be mounted on the printed board model.

8. A computer-readable recording medium for having stored therein a program for causing a computer to execute a design support process, the process comprising:
acquiring first CAD data that indicates a part model that models a part;
extracting characteristics of the part model from a plurality of outermost planes of the part model on a plane-by-plane basis, the part model being indicated by the first CAD data; and
determining, in the case where the characteristics extracted by the extracting satisfy a certain condition, an outermost plane corresponding to the characteristics as a surface of the part to be mounted on a printed board that is modeled by a printed board model indicated by second CAD data.

9. A method for executing a design support process by a computer, the method comprising:
acquiring first CAD data that indicates a part model that models a part;
extracting characteristics of the part model from a plurality of outermost planes of the part model on a plane-by-plane basis, the part model being indicated by the first CAD data; and
determining, in the case where the characteristics extracted by the extracting satisfy a certain condition, an outermost plane corresponding to the characteristics as a surface of the part to be mounted on a printed board that is modeled by a printed board model indicated by second CAD data.
